(19) United States
(12) Patent Application Publication
(10) Pub. No.: US 2010/0030569 A1
(43) Pub. Date: Feb. 4, 2010

(54) Party place recommendation apparatus and program

(75) Inventors: Kensuke OKANO, Kawasaki (JP); Tetsuya MIZUKAMI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/385,069

(22) Filed: Mar. 30, 2009

(30) Foreign Application Priority Data
Jul. 31, 2008 (JP) 2008-197299

(51) Int. Cl. G06Q 99/00; G06N 5/02; G06F 15/16; G06Q 50/00

(52) U.S. Cl. 705/1; 706/46; 709/204

(57) ABSTRACT

In a party place recommendation apparatus, an acquisition unit acquires party information on a party to be held. A selector selects party places to be recommended from among the potential party places indicated by party place information, based on attendee information stored in an attendee information storage unit, the party place information stored in a party place information storage unit, and the party information acquired by the acquisition unit. An output unit outputs recommendation information indicative of the party places selected by the selector.

### CROSS-REFERENCE TO RELATED APPLICATIONS

This application is based upon and claims the benefit of priority of the prior Japanese Patent Application No. 2008-197299, filed on Jul. 31, 2008, the entire contents of which are incorporated herein by reference.

### FIELD

The embodiment discussed herein is related to a party place recommendation apparatus and program.

### BACKGROUND

For selecting a meeting facility for holding an event or the like, there is a known technique of selecting a meeting facility based on all-inclusive meeting cost (for example, Published Japanese Translation No. 2003-517657 of the PCT International Publication).

In addition, as a restaurant search system for personal use, there is a known system which searches restaurants based on the number of attendees, cost, food, and so on (for example, Japanese Laid-open Patent Publication No. 2006-323805).

However, there are drawbacks to consider. Even if a good restaurant is found through search, most of attendees may not get excited but feel bored with the restaurant if they have been there a lot. As a result, they may not be satisfied.

Further, in addition to geographical conditions such as attendees' working places and addresses and a charge for a party place, the attendees have different tastes in food and locations, and different activities such as recently visited restaurants. If a lot of people are expected to attend a party, it may be very hard for a party planner to select a party place which satisfies all of the attendees.

### SUMMARY

According to an aspect of the invention, the party place recommendation apparatus includes: an attendee information storage unit which stores attendee information which is information on attendees of a party to be held by a predetermined group; a party place information storage unit which stores party place information which is information on potential party places which could be a party place of the party; an acquisition unit which acquires party information which is information on the party; a selector which selects party places to be recommended from among the potential party places indicated by the party place information, based on the attendee information stored in the attendee information storage unit, the party place information stored in the party place information storage unit, and the party information acquired by the acquisition unit; and an output unit which outputs recommendation information indicative of the party places selected by the selector.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an overview of one embodiment;

FIG. 2 illustrates a system configuration of the embodiment;

FIG. 3 illustrates a hardware configuration of a processing server;

FIG. 4 is a block diagram illustrating the configuration of the processing server;

FIG. 5 illustrates an example structure of a party place table;

FIG. 6 illustrates an example structure of an attendee table;

FIG. 7 illustrates an example structure of a visit history table;

FIG. 8 illustrates an example structure of a weighting table;

FIG. 9 is a flowchart of a process of selecting party places to be recommended;

FIG. 10 is a flowchart of an information update process; and

FIG. 11 illustrates a recommendation screen.

### DESCRIPTION OF EMBODIMENT(S)

An embodiment of the present invention will be explained with reference to the accompanying drawings, wherein like reference numerals refer to like elements throughout.

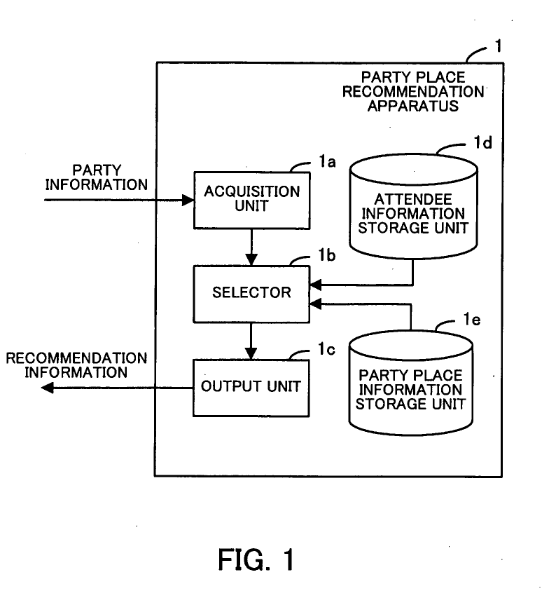

FIG. 1 is an overview of the embodiment. A party place recommendation apparatus 1 illustrated in FIG. 1 is designed to recommend party places for a party to be held by a predetermined group. The party place recommendation apparatus 1 includes an acquisition unit 1a, a selector 1b, an output unit 1c, an attendee information storage unit 1d, and a party place information storage unit 1e.

The acquisition unit 1a acquires party information on a party to be held. The party information is information on the party, such as a date and time of the party, attendee names, and the number of attendees.

The selector 1b selects party places to be recommended to a host or the like of the party from among potential party places indicated by party place information, based on attendee information stored in the attendee information storage unit 1d, the party place information stored in the party place information storage unit 1e, and the party information acquired by the acquisition unit 1a.

The output unit 1c outputs recommendation information indicative of the party places selected by the selector 1b to display the recommendation information on a display unit (not illustrated). This display unit may be provided in or separately from the party place recommendation apparatus 1.

In this connection, the recommendation information output from the output unit 1c may be stored in a computer or storage device (not illustrated). In this case, the stored recommendation information is displayed or read according to necessity.

The attendee information storage unit 1d stores the attendee information which is information on the attendees who will attend the party to be held by the predetermined group such as an office. Normally, the attendees are members who belong to the predetermined group. Considering an office as a group, for example, employees of the office are members. Considering a club as a group, as another example, club members are members. The attendee information includes attendee names, whereabouts (working place, house, etc.), and favorite food and drinks.

The party place information storage unit 1e stores the party place information which is information on potential party places which could be a place for the party. The potential party places include pubs, restaurants, bars, and hotels with banquet halls. The party place information includes the names of potential party places (restaurant name or the like), locations, available food and drinks.

In such the party place recommendation apparatus 1, the attendee information storage unit 1d stores the attendee information. The party place information storage unit 1e stores the party place information. The acquisition unit 1a acquires party information. The selector 1b selects party places to be recommended based on the attendee information, the party place information, and the party information. The output unit 1c outputs recommendation information indicative of the party places selected by the selector 1b.

As described above, the selector 1b selects the party places to be recommended based on the attendee information, which is information on the attendees of the party to be held by the predetermined group, and thereby making it possible to recommend party places suitable for the attendees who belong to the group having a predetermined range of people.

The embodiment will now be described with reference to the accompanying drawings.

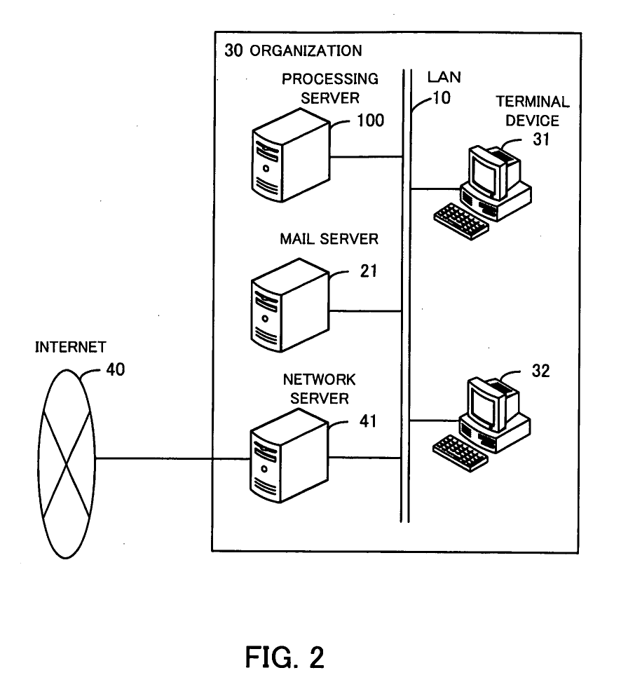

FIG. 2 illustrates the system configuration according to the embodiment. The party place recommendation system illustrated in FIG. 2 supports a user, who is one of the members of an organization 30, to determine a party place by accessing and interacting with a processing server 100 through a terminal device 31, 32 which the user uses, in the organization 30 having a predetermined range of members, such as an office. The range of members which forms the organization 30 can be determined depending on a situation. Considering an office, one section of the office or the entire office may be taken as the organization 30. Or a certain group, such as a club or an association, in the organization 30 may be also taken as the organization 30.

In the party place recommendation system according to the embodiment, the terminal devices 31 and 32 are connected via a Local Area Network (LAN) 10 to the processing server 100 which is designed to recommend party places, a mail server 21 which manages transmission/reception of electronic mails, and a network server 41 which can be connected to the Internet 40.

The processing server 100 is provided with a function of collecting information from external servers via the network server 41 and the Internet 40. Thereby, the processing server 100 can collect information on party places.

In addition, the processing server 100 is provided with a function of collecting information from electronic mails which were communicated within the organization 30 or between the organization 30 and the outside thereof via the network server 41 and the Internet 40 and have been stored in the mail server 21. Thereby, the processing server 100 can collect information on visits of the members of the organization 30 to party places and information on a party to be held.

The terminal devices 31 and 32 are computers which the users of the organization 30 use for their work or other purposes. The terminal devices 31 and 32 are provided with a function of transmitting and receiving electronic mails via the mail server 21 within the organization 30 and to/from the outside of the organization 30 via the Internet 40. In addition, the terminal devices 31 and 32 can make use of a party place recommendation function provided by the processing server 100.

The mail server 21 can be connected to external terminal devices (not illustrated) via the network server 41 and the Internet 40. The mail server 21 is a server which transmits/receives electronic mails within the organization 30 and between the organization 30 and the outside thereof.

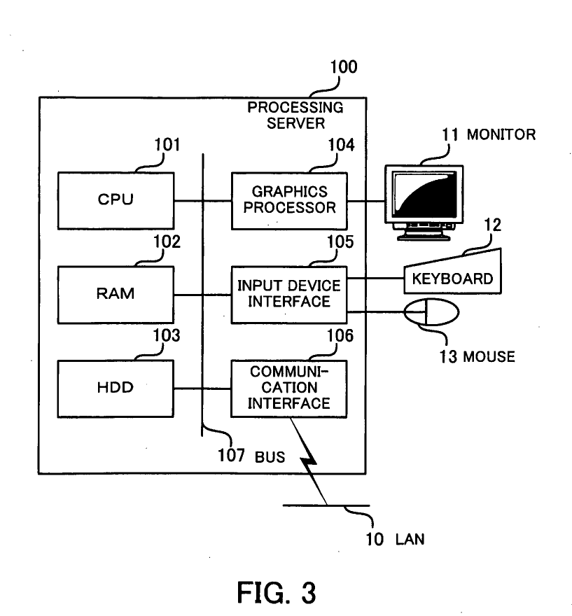

FIG. 3 illustrates the hardware configuration of the processing server. The processing server 100 illustrated in FIG. 3 is entirely controlled by a central processing unit (CPU) 101. Connected to the CPU 101 via a bus 107 are a Random Access Memory (RAM) 102, a Hard Disk Drive (HDD) 103, a graphics processor 104, an input device interface 105, and a communication interface 106.

The RAM 102 temporarily stores at least a part of an Operating System (OS) program and applications programs to be executed by the CPU 101. The RAM 102 also stores various kinds of data necessary for CPU processing. The HDD 103 stores the OS and application programs.

The graphics processor 104 is connected to a monitor 11 and is designed to display images on a display of the monitor 11 under the control of the CPU 101. The input device interface 105 is connected to a keyboard 12 and a mouse 13, and is designed to transfer signals from the keyboard 12 and the mouse 13 to the CPU 101 via the bus 107.

The communication interface 106 is connected to a network such as a LAN 10, and is designed to communicate data with other computers via such the network. The communication interface 106 can also be connected to another network such as the Internet 40.

In this connection, the mail server 21, the terminal devices 31 and 32, and the network server 41 can be realized with the same hardware configuration as the processing server 100. However, the communication interfaces of the mail server 21 and the terminal devices 31 and 32 are connected to the LAN 10, and the communication interface of the network server 41 is connected to the Internet 40.

With the above-described hardware configuration, the processing functions of the embodiment can be realized.

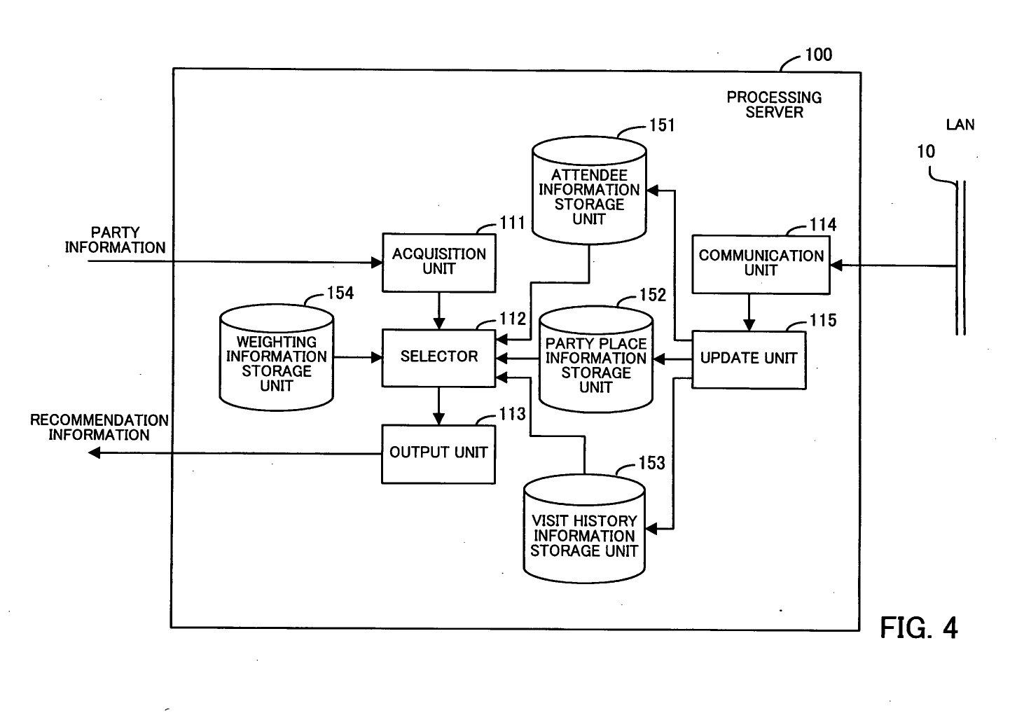

FIG. 4 is a block diagram of the configuration of the processing server. The processing server 100 illustrated in FIG. 4 is designed to be able to recommend party places for a party to be held by the predetermined organization 30. The processing server 100 has an acquisition unit 111, a selector 112, an output unit 113, a communication unit 114, an update unit 115, an attendee information storage unit 151, a party place information storage unit 152, a visit history information storage unit 153, and a weighting information storage unit 154.

The acquisition unit 111 acquires party information on a party to be held. The party information is information on the party, such as a date and time, attendee names, and the number of attendees. In this connection, the acquisition unit 111 may be designed to be able to acquire mail information on electronic mails from the mail server 21 (described above with reference to FIG. 2) by communicating with the mail server 21 via the communication unit 114.

The selector 112 selects party places to be recommended to a host or the like of the party from among potential party places indicated by the party place information, based on the attendee information stored in the attendee information storage unit 151, the party place information stored in the party place information storage unit 152, and the party information acquired by the acquisition unit 111.

The selector 112 is capable of evaluating potential party places, which are indicated by the party place information, by comparing the whereabouts information of the attendee information with the location information of the party place information, and selecting party places to be recommended from among the potential party places based on the evaluation results. Further, the selector 112 is capable of comparing the preference information of the attendee information with the offering information of the party place information, and selecting party places to be recommended from among the potential party places, which are indicated by the party place information, based on the comparison results. Furthermore, the selector 112 is capable of selecting party places which not many attendees have visited based on visit history information.

Furthermore, the selector 112 is capable of selecting party places to be recommended from among the potential party places based on weighting information. To this end, in evaluating the potential party places, the selector 112 gives greater weight to results of evaluating the potential party places based on the attendee information and visit history information of Very Important Person (VIP) attendees specified by VIP information. Alternatively, the selector 112 may give greater weight to results of evaluating the potential party places in terms of location, available food, etc.

On the other hand, the selector 112 can exclude potential party places based on the location information of the party place information. By previously excluding potential party places which are not necessary to be recommended as choices for a party place in terms of their locations, loads on the selector 112 for selection and on the output unit 113 for outputting to the terminal device 31 can be reduced.

The output unit 113 outputs recommendation information indicative of the party places selected by the selector 112 so as to display a list of the party places sorted based on the evaluation results on the monitor (not illustrated) of the terminal device 31. Alternatively, the list of the recommendations may be displayed on the monitor 11 connected to the processing server 100.

In addition, the recommendation information output from the output unit 113 may be stored in a computer or storage device (not illustrated). In this case, the stored recommendation information is displayed or read according to necessity.

The communication unit 114 communicates via the LAN 10 with the mail server 21, which manages transmission and reception of electronic mails. This enables the acquisition unit 111 to acquire mail information on electronic mails stored in the mail server 21.

The update unit 115 updates the attendee information stored in the attendee information storage unit 151, the party place information stored in the party place information storage unit 152, and the visit history information stored in the visit history information storage unit 153. At this time, the update unit 115 updates the attendee information, the party place information, and the visit history information based on the mail information acquired by the acquisition unit 111.

The attendee information storage unit 151 stores the attendee information, which is information on the attendees of the party to be held by the predetermined organization 30 such as an office. Normally, the attendees are members who belong to the predetermined organization 30 and will attend the party to be held by the organization 30. Considering an office as the organization 30, for example, its employees are members of the organization 30. Considering a club as the organization 30, as another example, its club members are members of the organization 30. The attendee information includes the attendee names, whereabouts information (working place, location of home, etc.) which is information on attendees' whereabouts, and preference information which is information on attendees' favorite food and drinks.

The party place information storage unit 152 stores the party place information which is information on the potential party places which could be a place for the party to be held. The potential party places may be bars, restaurants, pubs, and hotels with banquet halls. The party place information includes the names of potential party places (restaurant name, etc.), location information which is information on the locations of the potential party places, offering information which is information on available food and drinks (menu, alcohol, etc.).

The visit history information storage unit 153 stores the visit history information indicating a history of attendees' visits to potential party places. By using this visit history information, a high evaluation value can be given to a party place which has never been visited or has not lately visited by the attendees, so as to prevent the attendees from getting bored with a party place and to increase attendees' satisfaction.

The weighting information storage unit 154 stores the weighting information indicating how much to weight each evaluation factor when the selector 112 selects party places. The weighting information includes the VIP information specifying VIP attendees of the party. The VIP attendees are people who are especially hoped to be satisfied with the party, such as main guests of the party, bosses of an office, or people who have particular tastes in food, drinks, or party place.

The example data structure of data to be used in the embodiment will now be described.

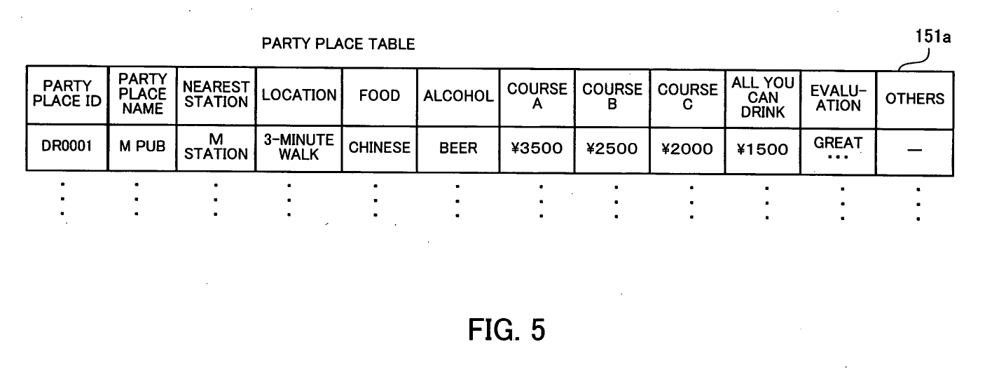

FIG. 5 illustrates the example structure of a party place table. The party place table 151a illustrated in FIG. 5 is created and managed by the processing server 100 (described before with reference to FIG. 3), and is stored on the HDD 103 (described before with reference to FIG. 3). The party place table 151a is a table which stores the party place information, which is information on potential party places (restaurants) which could be a party place.

The party place table 151a has columns for following items: “party place ID”, “party place name”, “nearest station”, “location”, “food”, “alcohol”, “course”, “all you can drink”, “evaluation”, and “others”. The “party place ID” column contains a code uniquely identifying a party place. The “party place name” column indicates the name of the party place. The “nearest station” column indicates a station nearest to the party place. The “location” column indicates a time to be taken from the nearest station to the party place. The “food” column indicates main food to be served at the party place. The “alcohol” column indicates main alcohol to be served at the party place. The “course” column indicates course menus offered at the party place. The “all you can drink” column indicates whether all-you-can-drink option is available, and if yes, its price. The “evaluation” column indicates evaluations of the party place made by the members of the organization 30. The “others” column indicates other information on the party place. The information items arranged in a row are associated with one another to form party place information.

Members who make use of the party place recommendation function provided by the processing server 100 enter their reviews and additional information, so as to record actual evaluations and other information of party places. As the evaluations, a member who actually went to a party place enters his review of the party place. As the other information, the member enters special information on the party place such as special offers. This information entered in the “evaluation” and “others” columns can be displayed by using the terminal device 31 or the like.

The processing server 100 according to the embodiment creates the party place information by accepting inputs of members to the processing server 100 or by automatically collecting information over the Internet 40, and stores it on the HDD 103 of the processing server 100.

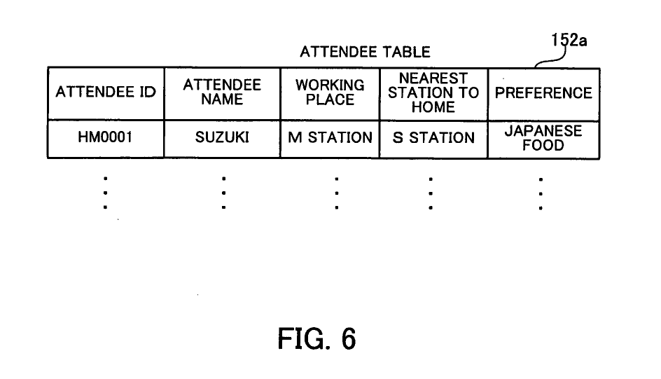

FIG. 6 illustrates the example structure of an attendee table. The attendee table 152a illustrated in FIG. 6 is created and managed by the processing server 100 (described before with reference to FIG. 3), and is stored on the HDD 103 (described above with reference to FIG. 3). The attendee table 152a is a table which stores the attendee information which is information on members who belong to the organization 30 and will attend a party to be held by the organization 30.

The attendee table 152a has columns for following items: “attendee ID”, “attendee name”, “working place”, “nearest station to home”, and “preference”. The “attendee ID” column contains a code uniquely specifying an attendee. The “attendee name” column indicates the name of the attendee. The “working place” column indicates the nearest station to the working place of the attendee. The “nearest station to home” column indicates the nearest station to the attendee's home. The “preference” column indicates attendee's preference. The information items arranged in a row are associated with one another to form attendee information.

In the processing server 100 according to the embodiment, information on members who make use of the party place recommendation function of the processing server 100 is stored as the attendee information. The processing server 100 creates the attendee information by accepting inputs of members to the processing server 100 or by accessing the mail server (not illustrated) to automatically collect information from electronic mails communicated within the organization 30, and stores it on the HDD 103.

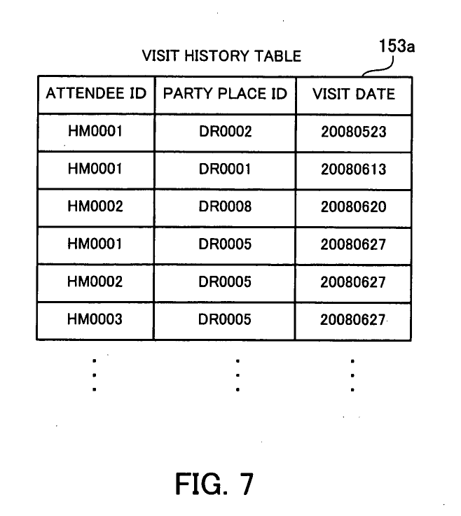

FIG. 7 illustrates an example structure of a visit history table. The visit history table 153a illustrated in FIG. 7 is created and managed by the processing server 100 (described before with reference to FIG. 3), and is stored on the HDD 103 (described before with reference to FIG. 3). The visit history table 153a is a table which stores visit history information indicative of a history of past visits of members of the organization 30 to potential party places which could be a place for a party.

The visit history table 153a has columns for following items: “attendee ID”, “party place ID”, and “visit date”. The “attendee ID” column contains a code uniquely identifying an attendee. The “party place ID” column contains a code uniquely identifying a party place the attendee visited. The “visit date” column indicates when the attendee visited the party place. Information items arranged in a row are associated with one another to form visit history information.

The visit history information is linked to the attendee information via an attendee ID, and is also linked to the party place information via a party place ID. Because of these links, it can be known which party place, when, and how many times each member visited.

In the processing server 100 according to this embodiment, information on a history of members' visits to party places is stored as visit history information. The processing server 100 creates the visit history information by accepting inputs of members to the processing server 100 or by accessing the mail server (not illustrated) to automatically collect information from electronic mails communicated within the organization 30, and stores it on the HDD 103.

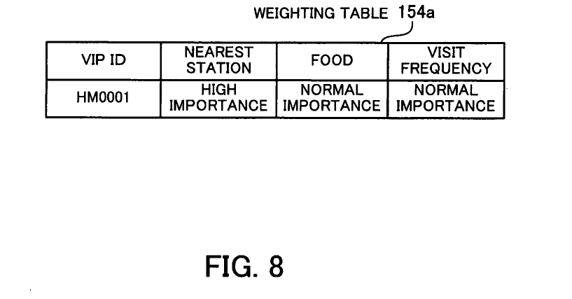

FIG. 8 illustrates an example structure of a weighting table. The weighting table 154a illustrated in FIG. 8 is created and managed by the processing server 100 (described before with reference to FIG. 3), and is stored on the HDD 103 (described before with reference to FIG. 3). The weighting table 154a is a table which stores weighting information indicating how much to weight each evaluation factor in evaluating party places to be recommended as choices for the party place of the party to be held by the organization 30.

The weighting table 154a has columns for following items: “VIP ID”, “nearest station”, “food”, and “visit frequency”. The “VIP” column contains a code uniquely identifying a VIP attendee of a party to be held. The “nearest station” column indicates whether the VIP attendee considers the nearest station to a party place to be very important in selecting a party place. The “food” column indicates whether the VIP attendee considers the main food to be served at the party place to be very important in selecting a party place. The “visit frequency” column indicates whether the VIP attendee considers the visit frequencies of attendees to be very important in selecting a party place. Information items arranged in a row are associated with one another to form weighting information.

As a VIP ID, the attendee ID of a VIP attendee which is stored in the attendee table 152a (described before with reference to FIG. 6) is used, so that the VIP attendee can be specified by means of the VIP ID.

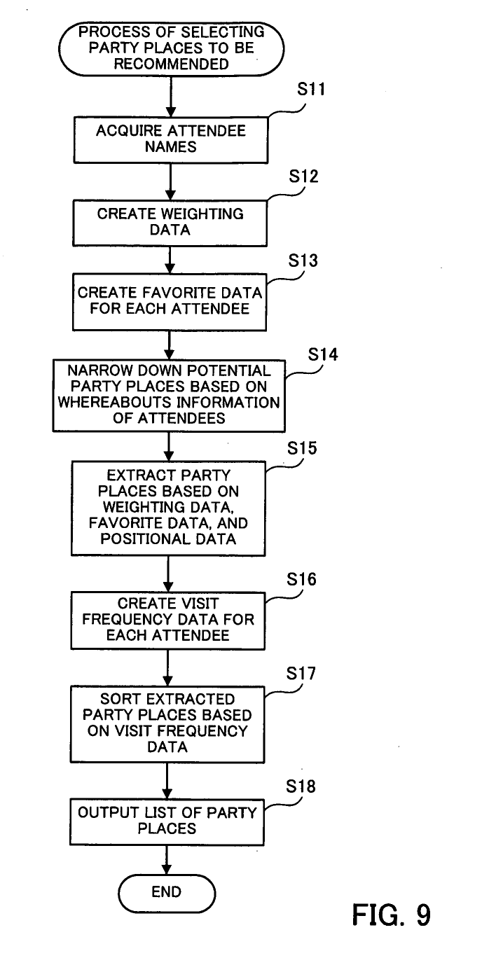

The processing server 100 performs a process of selecting party places to be recommended, which will be described later in FIG. 9, thereby selecting and outputting the recommended choices for a party place based on the weighting information.

In the processing server 100 according to this embodiment, information indicating how much to weight each evaluation factor in evaluating party places to be recommended for the party place of the party to be held is created based on how much VIP attendees, who are very important attendees of the party, consider the evaluation factor to be important, and is stored as weighting information. The processing server 100 creates the weighting information by accepting inputs of members to the processing server 100 or by accessing the mail server (not illustrated) to automatically collect information from electronic mails communicated within the organization 30, and stores it on the HDD 103.

The processes to be executed in this embodiment will now be described.

FIG. 9 is a flowchart of a process of selecting party places to be recommended. This process illustrated in FIG. 9 is performed by the processing server 100 to select party places to be recommended as choices for a party place. After a party is planned and it is determined who will attend the party, this process is executed by a member activating the party place recommendation function.

Step S11: The CPU 101 of the processing server 100 accepts inputs from attendees, and recognizes who will attend the party. More specifically, for example, the terminal device 31 accepts inputs indicative of attendees from members, and sends data about the attendees to the processing server 100 via the LAN 10 (described before with reference to FIG. 2). By receiving the data, the processing server 100 acknowledges the attendees.

To obtain attendee names, the processing server 100 may extract data about attendees from party-related electronic mails sent to the processing server 100 with reference to the carbon copy (CC) of the party-related electronic mails communicated between the members, and recognize from the extracted data who will attend the party. Alternatively, the processing server 100 may automatically extract attendee names from party-related electronic mails out of electronic mails stored in the mail server (not illustrated), and recognize who will attend the party.

Step S12: The CPU 101 creates weighting data which is used in evaluating potential party places which could be choices for the party place, based on the attendee names obtained at step S11.

For example, in the case where a main guest is invited to the party, weighting coefficients of favorite data, positional data, visit frequency data of the main guest may be made higher, so that the attendee data of the main guest can have a greater influence.

In addition, in the case where a party place which no member has visited is desirable, for example, party places which have not been visited can be easily recommended in such a way that the visit frequencies of the attendees are made to have a greater influence than any other evaluation factors such as preference and nearest station to home of each attendee, so as to extract only party places which have a low visit frequency in view of the visit history information.

Step S13: The CPU 101 creates favorite data for each of the attendees acknowledged at step S11.

The favorite data is created by expressing in figures results of evaluating each potential party place in a point of view of each attendee based on the “working place”, “nearest station to home”, and “preference” of the attendee information, and the “nearest station”, “food”, “evaluation”, and “others” of the party place information.

For example, if the food indicated by “preference” of attendee information matches the food indicated by “food” of party place information, a high numerical evaluation value is given as the attendee's evaluation of the party place in terms of “preference”. Otherwise a low numerical evaluation value is given. In addition, the shorter time it takes by train between the station indicated by “working place” of the attendee information and the station indicated by “nearest station” of the party place information, the higher numerical evaluation value is given as the attendee's evaluation of the party place in terms of “working place”. This also means that the longer time it takes, the lower numerical evaluation value is given. With respect to the other items, in a point of view of each attendee, a numerical evaluation value is given as the attendee's evaluation of the party place in the same way.

Step S14: The CPU 101 narrows down the potential party places based on the whereabouts information included in the attendee information of the attendees acknowledged at step S11. Then, the CPU 101 creates positional data indicating the remaining potential party places.

In this embodiment, the potential party places are narrowed down based on a route and time schedule information acquired from Web or the like, by using information about the nearest station to each party place and a time travel on foot based on the working place and the nearest station to home of the attendee information of each attendee. In this connection, as these information are part of favorite data, it is used in creating the favorite data at step S13.

Step S15: The CPU 101 extracts plural choices for the party place based on the weighting data created at step S12, the favorite data created at step S13, and the positional data created at step S14.

More specifically, based on the weighting data created at step S12 and the favorite data created at step S13 in view of the positional data created at step S14, the evaluation values of each party place are aggregated, and the aggregation result is set as points of the party place. Then, based on the aggregation results and under predetermined criteria such as only party places with a predetermined threshold or greater or only a predetermined number of party places with higher points, party places are extracted as choices for the party place.

Step S16: The CPU 101 creates visit frequency data obtained by calculating visit frequency of each of the attendees acknowledged at step S11 to the party places extracted at step S15.

In this embodiment, quantitative evaluation is adopted. More specifically, the more number of times an attendee has visited a party place, the lower evaluation value the party place gets, and on the contrary, the less number of times an attendee has visited a party place, the higher evaluation value the party place gets. In this connection, not only the number of visits but also a temporal element may be introduced. For example, weighting may be performed based on the number of times of visits in such a way that a recent visit causes a greater influence while a past visit causes a smaller influence.

Step S17: The CPU 101 sorts the party places extracted at step S15 based on the visit frequency data created at step S16.

In this embodiment, considering both the points given to the party places at step S15 and the visit frequency data created at step S16, the party places are sorted in decreasing order of evaluation. This sorting is not limited to this. The party places extracted at step S15 may be sorted in increasing order of visit frequency.

Step S18: The CPU 101 outputs a list of the party places sorted at step S17. The processing server 100 sends the recommendation information including the list of the sorted party places to the terminal device 31. The terminal device 31 stores the list of the party places included in the received recommendation information, and displays it on a monitor (not illustrated) connected thereto, in response to a request from a member operating the terminal device 31.

In this connection, in this embodiment, the visit frequencies of the attendees calculated at step S16 are used at step S18 to sort the extracted party places at step S17. However, the visit frequencies may be used together with the attendee information to extract party places.

In addition, the potential party places which are to be evaluated may be limited under predetermined criteria before favorite data which indicates evaluations of party places in attendee's point of view is created at step S13. For example, the limitation criteria to be previously set may be a geographic limit regarding the locations of party places (for example, within a predetermined distance from a station). This narrows down potential party places to be evaluated, thus making it possible to reduce a load of creating the favorite data.

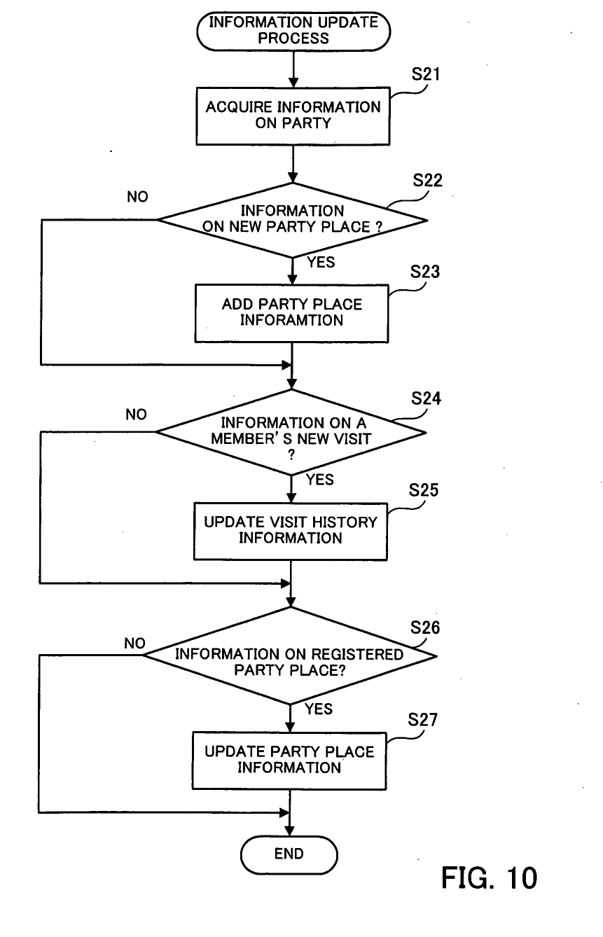

FIG. 10 is a flowchart of an information update process. The information update process illustrated in FIG. 10 is a process which is performed by the processing server 100 to automatically update party place information and visit history information. This process is started when the processing server 100 obtains new data including information on a party such as party place information or visit history information.

Step S21: The CPU 101 obtains information on a party such as party place information or visit history information. At this time, the processing server 100 can acquire data which a member entered with the terminal device 31. Alternatively, the CPU 101 may extract a keyword regarding the party from the text data of the body of an electronic mail, and obtain party place information or visit frequency information based on the extracted keyword. The electronic mail from which the processing server 100 obtains information may be one which is destined for and received by the processing server 100 or one which is stored in the mail server (not illustrated).

Step S22: The CPU 101 determines whether the data acquired at step S21 include information on a new party place which has not been registered in the party place information. If information on a new party place is included, the process goes on to step S23. If it is not included, the process goes on to step S24.

Step S23: The CPU 101 creates party place information of the new party place from the information on the new party place included in the data acquired at step S21. Then, the CPU 101 assigns and registers a new party place ID to the created party place information in the party place table 151a (described before with reference to FIG. 5).

If the obtained data includes only some items of party place information of the new party place, the processing server 100 may acquire the other details over the Internet 40. For example, if the obtained data include only the name of the party place, the processing server 100 may use an available search engine to search information published by other servers (not illustrated) connected to the Internet 40 via the Internet 40 based on the name of the party place to find out the other items of the party place information such as nearest station, location, available food and drinks, course menus, whether all you can drink option is available or not and its cost, and other information on the party place, so as to automatically create the other items of the party place information.

Step S24: The CPU 101 determines whether the data acquired at step S21 include information on a member's new visit history to a party place. If information on the member's new visit history to a party place is included, the process goes on to step S25. If it is not included, the process goes on to step S26.

Step S25: The CPU 101 updates visit history information for the party place based on the information on member's visit to the party place included in the data acquired at step S21. In this step, the processing server 100 updates only the visit history information for new visits of already registered members. A new member is added by storing in the attendee table 152a (described before with reference to FIG. 6) attendee information created based on information entered by a member to the terminal device 31.

Step S26: The CPU 101 determines whether the data acquired at step S21 includes information on a registered party place. If information on a registered party place is included, the process proceeds to step S27. If it is not included, the process is completed.

Step S27: The CPU 101 updates the party place information in the party place table 151a based on the information on the registered party place included in the data acquired at step S21. In this step, the processing server 100 updates only the party place information on registered party places. Adding party place information on a new party place is performed at step S23.

A display screen in the embodiment will now be described.

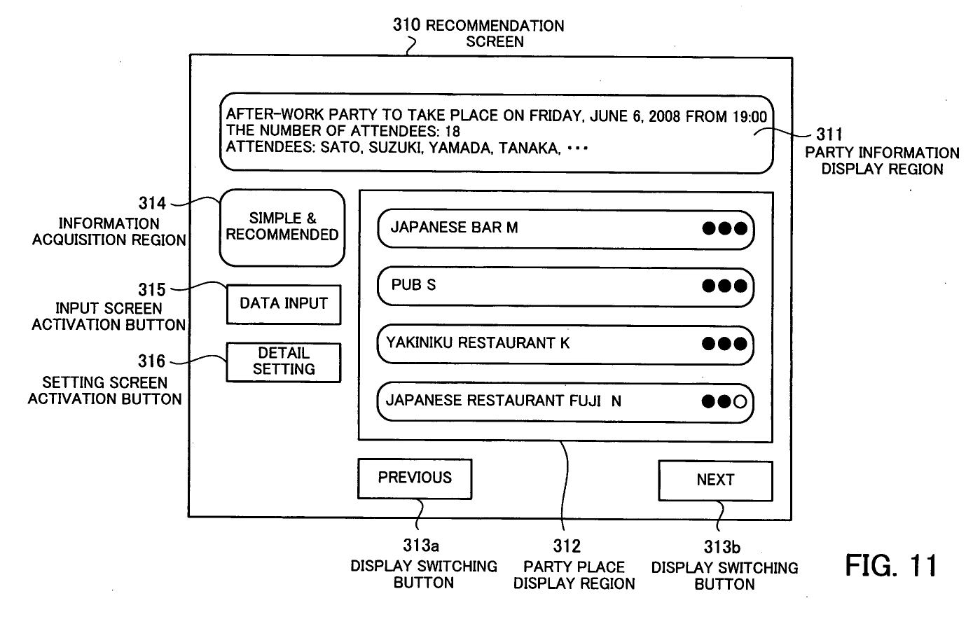

FIG. 11 illustrates a recommendation screen. The recommendation screen 310 illustrated in FIG. 11 is a screen which is displayed on a monitor (not illustrated) of the terminal device 31 (described before with reference to FIG. 2), and this is just an example of a screen presented for displaying party places recommended by the party place recommendation function of the processing server 100.

The recommendation screen 310 is provided with a party information display region 311 for displaying information on a party to be held, a party place display region 312 for displaying the party places recommended by the party place recommendation function of the processing server 100, display switching buttons 313a and 313b for switching a display of party places currently displayed in the party place display region 312, an information acquisition region 314 for acquiring information from electronic data such as an electronic mail dragged and dropped by a member operating a mouse (not illustrated), an input screen activation button 315 for activating an input screen (not illustrated) which is a screen for the user to input data, and a setting screen activation button 316 for activating a setting screen (not illustrated) which is a screen for the user to input setting information.

The party information display region 311 displays party information on a party to be held, for which party places are recommended by the party place recommendation function of the processing server 100. This party information includes the date and time of the party, the purpose of the party such as “after-work party”, “welcoming/farewell party”, “new year party”, or “year-end party”, the number of attendees, attendee names, and so on.

The party place display region 312 displays a list of party places output from the processing server 100 performing the process of selecting party places to be recommended (described before with reference to FIG. 9).

In this example, the rating of each party place is represented by a filled circle mark “” and an open circle mark “◯”. The greater number of filled circle means higher points. More specifically, the three filled circle marks “” indicate the highest rating, and the marks “◯” are the next highest. Then, the marks “◯◯” follow. The marks “◯◯◯” are the lowest. These marks allow ratings to be recognized immediately although the rating points of party places are rough indication. Alternatively, the points of party places may be displayed in form of numerals or graph for detailed comparison.

The display switching buttons 313a and 31b are buttons for switching a list of party places currently displayed in the party place display region 312. When the user presses the display switching button 313a with a mouse or the like, the list of party places currently displayed is switched to a list of party places with higher points. If the display switching button 313b is pressed, the list of party place currently displayed is switched to a list of party places with lower points.

The information acquisition region 314 is a region where information is extracted from data dragged and dropped by the member. The processing server 100 may extract information from the data such as the electronic mail dragged and dropped onto the information acquisition region 314 with the information update process (described before with reference to FIG. 10).

The input screen activation button 315 is a button for activating a data input screen (not illustrated) which is used for the member to enter data. The data input screen is displayed on the monitor of the terminal device 31 which the member operates. The member uses this data input screen to newly enter or update the party place information stored in the party place table 151a (described before with reference to FIG. 5), the attendee information stored in the attendee table 152a (described before with reference to FIG. 6), and the visit history information stored in the visit history table 153a (described before with reference to FIG. 7).

The setting screen activation button 315 is a button for activating a setting screen (not illustrated) which is used for the member to enter data. The setting screen is displayed on the monitor of the terminal device 31 which the member operates. The member uses the setting screen to enter the setting details for the party place recommendation function of the processing server 100.

As described above, in the embodiment, the party place recommendation function of the processing server 100 is capable of recommending party places suitable for the attendees of a party to be held by the organization 30. This results in selecting a party place which provide more satisfactory for the attendees of the party to be held by the prescribed group.

The processing functions described above can be realized by a computer. In this case, a program is prepared, which describes processes for the functions to be performed by the processing server 100. The program is executed by a computer, whereupon the aforementioned processing functions are accomplished by the computer.

The program describing the required processes may be recorded on a computer-readable recording medium. Computer-readable recording media include magnetic recording devices, optical discs, magneto-optical recording media, semiconductor memories, etc. The magnetic recording devices include Hard Disk Drives (HDD), Flexible Disks (FD), magnetic tapes, etc. The optical discs include Digital Versatile Discs (DVDs), DVD-RAM, Compact Disc-Read Only Memory (CD-ROM), CD-R (Recordable)/RW (Rewritable), etc. The magneto-optical recording media include MO Magneto-Optical (MO) disks etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer runs the program. The computer may run the program directly from the portable recording medium. Also, while receiving the program being transferred from the server computer, the computer may sequentially run this program.

The disclosed party place recommendation apparatus and program can provide recommendations of party places suitable for the attendees of a party to be held by a predetermined group.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that various changes, substitutions and alterations could be made hereto without departing from the spirit and scope of the invention.

What is claimed is:

1. A party place recommendation apparatus comprising:
an attendee information storage unit which stores attendee information which is information on attendees of a party to be held by a predetermined group;
a party place information storage unit which stores party place information which is information on potential party places which could be a party place of the party;
an acquisition unit which acquires party information which is information on the party;
a selector which selects party places to be recommended from among the potential party places indicated by the party place information, based on the attendee information stored in the attendee information storage unit, the party place information stored in the party place information storage unit, and the party information acquired by the acquisition unit; and
an output unit which outputs recommendation information indicative of the party places selected by the selector.

2. The party place recommendation apparatus according to claim 1, wherein:
the attendee information includes whereabouts information which is information on whereabouts of the attendees;
the party place information includes location information which is information on locations of the potential party places;
the selector evaluates the potential party places by comparing the whereabouts information of the attendee information and the location information of the party place information, and selects the party places to be recommended from among the potential party places indicated by the party place information based on evaluation results.

3. The party place recommendation apparatus according to claim 1, wherein:
the attendee information includes preference information which is information on favorite food and drinks of the attendees;
the party place information includes offering information which is information on available food and drink to be served at the potential party places; and
the selector compares the preference information of the attendee information with the offering information of the party place information, and selects the party places to be recommended from among the potential party places indicated by the party place information based on comparison results.

4. The party place recommendation apparatus according to claim 1, further comprising a visit history information storage unit which stores visit history information indicative of a history of visits of the attendees to the potential party places, wherein
the selector selects the party places with few visits of the attendees based on the visit history information.

5. The party place recommendation apparatus according to claim 1, further comprising a weighting information storage unit which stores weighting information indicating how much to weight each evaluation factor in the selecting of the selector, wherein
the selector selects the party places to be recommended from among the potential party places based on the weighting information.

6. The party place recommendation apparatus according to claim 5, wherein:
the weighting information includes very important person (VIP) information specifying a VIP attendee of the party; and
the selector evaluates the potential party places by giving greater weight to results of evaluating the potential party places based on the attendee information and the visit history information of the VIP attendee specified by the VIP information, and selects the party places to be recommended from among the potential party places.

7. The party place recommendation apparatus according to claim 2, wherein the selector excludes potential party places based on the location information of the party place information.

8. The party place recommendation apparatus according to claim 4, further comprising:
a communication unit which communicates with a mail management device which manages transmission/reception of electronic mails; and
an update unit which updates the attendee information stored in the attendee information storage unit, the party place information stored in the party place information storage unit, and the visit history information stored in the visit history information storage unit, wherein:
the acquisition unit communicates with the mail management device via the communication unit to acquire mail information which is information on the electronic mails from the mail management device; and
the update unit updates the attendee information, the party place information, and the visit history information based on the mail information acquired by the acquisition unit.

9. The party place recommendation apparatus according to claim 2, wherein the output unit outputs the recommendation information indicative of the party places selected by the selector so as to display a list of the party places sorted based on the evaluation results on a display unit.

10. A computer-readable recording medium containing a party place recommendation program causing a computer to perform as:
an acquisition unit which acquires party information on a party to be held by a predetermined group;
a selector which selects party places to be recommended from among potential party places indicated by party place information, based on attendee information, the party place information, and the party information acquired by the acquisition unit, the attendee information being information on attendees of the party and stored in an attendee information storage unit, the party place information being information on the potential party places which could be a party place of the party and stored a party place information storage unit; and
an output unit which outputs recommendation information indicative of the party places selected by the selector.
